(19) United States
(12) Patent Application Publication
(10) Pub. No.: US 2008/0184208 A1
(43) Pub. Date: Jul. 31, 2008

(54) METHOD AND APPARATUS FOR DETECTING VULNERABILITIES AND BUGS IN SOFTWARE APPLICATIONS

(76) Inventors: VUGRANAM C. SREEDHAR, Yorktown Heights, NY (US); Gabriela F. Cretu, New York, NY (US); Julian T. Dolby, Riverdale, NY (US)

Correspondence Address: PATTERSON & SHERIDAN, LLP, 595 Shrewsbury Avenue, Shrewsbury, NJ, 07702, US

(21) Appl. No.: 11/668,889

(22) Filed: Jan. 30, 2007

(51) Int. Cl. G06F 9/44

(52) U.S. Cl. 717/128

(57) ABSTRACT

In one embodiment, the present invention is a method and apparatus for detecting vulnerabilities and bugs in software applications. One embodiment of a method for detecting a vulnerability in a computer software application comprising a plurality of variables that have respective values and include data and functions includes detecting at least one piece of data that is tainted, tracking the propagation of the tainted data through the software application, and identifying functions that are security sensitive and that are reached by the tainted data its the propagation.

### BACKGROUND

The invention relates generally to computer security, and relates more particularly to detecting vulnerabilities and bugs in software applications.

Computer security aims to protect assets or information against attacks and/or threats to the confidentiality, integrity or availability of the assets. Confidentiality means that assets or information are accessible only in accordance with well-defined policies. Integrity means that assets or information are not undetectably corrupted and are alterable only in accordance with well-defined policies. Availability means that assets or information are available when needed. Poor focus on security analysis, however, causes software development organizations to struggle with security vulnerabilities that can be exploited by attackers. For example, a World Wide Web application might be vulnerable to a poisoned cookie or a cross-site scripting.

Detecting vulnerabilities in software applications requires a developer to compute and identify tainted variables and tainted data. A variable or piece of data is said to be tainted if its value comes from or is influenced by an external and/or untrusted source (e.g., a malicious user). Tainted data can propagate (flow through some channel, such as variable assignment, to a destination) within an application, tainting other variables and control flow predicates along the way. One way to reduce the risk of vulnerabilities due to tainted data is to sanitize the data by passing it to a sanitization function or a filter that transforms low-security objects into high-security objects. However, because different applications require different kinds of sanitization functions, it is often difficult or impossible to define the sanitization functions for many applications.

Detecting bugs in software applications requires a developer to compute and identify paths in a program that can lead to an error state. A variable or object is said to be in an error state if performing an operation on the variable or object can raise an exception or produce illegal output. The typestates of a variable comprise a set of states that the variable goes through during execution. The operations performed on a variable expect that the variable will be in certain typestates for the operations to be legal. For example, for the operation f.read( ) to execute correctly, the typestate of the variable f has to be open, and cannot be closed. Operations expect that the variables that are being operated on are in legal or correct states. If not, the operation is considered a bug.

Thus, there is a need for a method and an apparatus for detecting vulnerabilities and bugs in software applications.

### SUMMARY OF THE INVENTION

In one embodiment, the present invention is a method and apparatus for detecting vulnerabilities and bugs in software applications. One embodiment of a method for detecting a vulnerability in a computer software application comprising a plurality of variables that have respective values and include data and functions includes detecting at least one piece of data that is tainted, tracking the propagation of the tainted data through the software application, and identifying functions that are security sensitive and that are reached by the tainted data its the propagation.

In another embodiment, a method for detecting bugs in a software application comprising a plurality of variables that have respective values and include data and functions that operate on the data includes detecting at least one piece of data, the piece of data being in a first typestate, tracking the propagation of the first typestate through the software application, and identifying at least one function that is reached by the piece of the data, for which the first typestate is illegal.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates an exemplary PHP program in SSA form;

FIG. 1B illustrates the TSSA form counterpart program to program of FIG. 1;

FIG. 2 illustrates an exemplary Java program illustrating the global escape property;

FIG. 3 illustrates an exemplary PHP program illustrating the taint property;

FIG. 4A illustrates an exemplary program illustrating typestate and alias interaction;

FIG. 4B illustrates the TSSA form corresponding to the exemplary program of FIG. 4A;

FIG. 5 is a flow diagram illustrating one embodiment of a method for detecting vulnerabilities in a software application, according to the present invention;

FIG. 6A illustrates the SSA form for the exemplary program illustrated in FIG. 4;

FIG. 6B illustrates the SSA form for the exemplary program illustrated in FIG. 4, in which only SSA edges and nodes are illustrated;

FIG. 6C illustrates the TSSA form that corresponds to the SSA form illustrated in FIG. 6A;

FIG. 7 illustrates a typestate lattice operation;

FIG. 8A illustrates an example of an open;read class;

FIG. 8B illustrates the SSA form corresponding to the open:read class of FIG. 8A;

FIG. 8C illustrates the TSSA form corresponding to the SSA form of FIG. 8B;

FIG. 9 is a flow diagram illustrating one embodiment of a method for constructing the TSSA form from the SSA form, according to the present invention;

FIG. 10 is a flow diagram illustrating one embodiment of a method for detecting vulnerabilities in a software application, according to the present invention;

FIG. 11, for example, illustrates an exemplary sparse property implication graph for the method db_query( ) shown in FIG. 3; and

FIG. 12 is a high level block diagram of the vulnerability detection method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for detecting vulnerabilities and bugs in software applications. Embodiments of the present invention detect application vulnerabilities and bugs using a set of sparse techniques. Data flow and control flow vulnerabilities and typestates are unified using these sparse techniques in combination with a typestate static single assignment (TSSA) form. The result is an analysis that scales well to detect vulnerabilities and bugs even in large programs.

Static single assignment (SSA) form is a well-known intermediate representation of a program in which every variable is statically assigned only once. Variables in the original program are renamed (or given a new version number), and φ-functions (sometimes called φ-nodes or φ-statements) are introduced at control flow merge points to ensure that every use of a variable has exactly one definition. A φ-function generates a new definition of a variable by “choosing” from among two or more given definitions. φ-functions are not actually implemented; instead, they're just markers for the compiler to place the value of all the variables grouped together by the φ-function, in the same location in memory (or same register). A φ-function takes the form xₙ=φ(x₀, x₁, x₂, . . . , xₙ₋₁), where xᵢ's (i=0, . . . , n) comprise a set of variables with single static assignment. SSA form has some intrinsic properties that enable and simplify many compiler optimizations. Embodiments of the present invention propose a variation on the SSA form, referred to herein as typestate static single assignment (TSSA), that simplifies reasoning about typestate properties.

As will also be described in further detail below, the TSSA form is used to detect vulnerabilities and bugs in software programs based on taint analysis and typestate analysis. A piece of information or data is considered to be tainted whenever the data originates at a source that is considered to be untrusted (e.g., user input) and propagates/flows through some channel (e.g., variable assignment) to a destination that is considered to be trusted (e.g., access to a file system). Tainted data, while harmless in a program by itself, is a potential source of (dormant) vulnerability, even in applications that (currently) have no sensitive operations. For example, during software maintenance and refactoring, one could introduce sensitive operations that can trigger new vulnerabilities because of tainted data. Thus, taint analysis involves determining whether a trusted object can be “reached” by an untrusted object.

All data flow problems do not necessarily have the classical def-use form, and for those that do not, interprocedural sparse evaluation techniques still apply. Such problems are herein referred to as property implication problems (PIPs) and have the following characteristic: if a data flow property P₁ is true at program location l₁, then a data flow property P₂ is true at another program location l₂. In other words, property P₁ at location l₁ implies property P₂ and location l₂. However, if the property P₁ is not true at the location l₁, then nothing can be said about the property P₂ at the location l₂. Embodiments of the present invention propose a sparse representation of a program, referred to herein as a sparse property implication graph (SPIG), as an underlying representation for evaluating PIPs. As will be discussed in greater detail below, the SPIG can be used to summarize the effects of a procedure with respect to typestate verification (e.g., for shallow programs). The TSSA form is used as the basis for constructing the SPIG, and the combination of the TSSA form and the SPIG is then used to detect interprocedural security vulnerabilities in software programs.

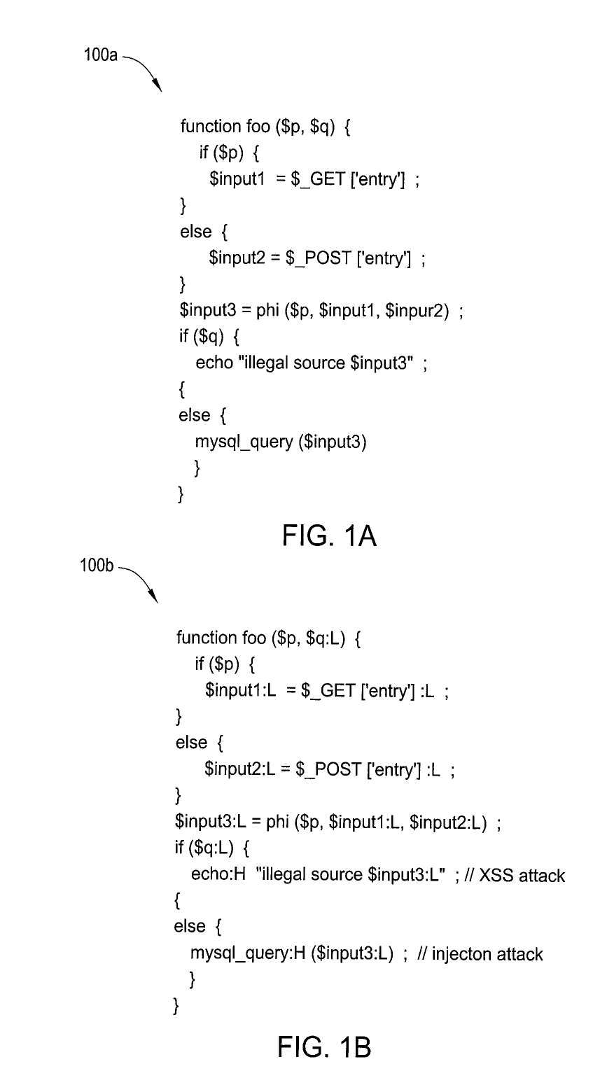

FIG. 1A illustrates an exemplary PHP program 100a in SSA form. For taint analysis purposes, two typestate labels are defined: L (low-security) and H (high-security). Thus, for the purposes of the present invention, a variable's typestate is an indicator that identifies the security level (i.e., low or high) of the variable. In one embodiment, all user inputs and uninitialized variables are labeled with typestate L, while sensitive functions (i.e., functions that operate on potentially confidential information) are labeled with typestate H. Thus, in the example of FIG. 1A, typestate L is associated with _GET and _POST, since these functions receive input values from an (untrusted) external client. The echo operation is labeled as a high-security (H) operation, since it can potentially pass confidential information to the external client. Also, because the echo function sends client requests, this can potentially induce cross-site scripting attacks.

For confidentiality purposes, information from H-labeled entities cannot flow into L-labeled entities. For integrity purposes, information from L-labeled entities cannot flow into H-labeled entities. FIG. 1B illustrates the TSSA form counterpart program 100b to program 100a of FIG. 1, including the L and H labels. As illustrated, the echo operation is considered to be high-security, while the operation's parameter, fname3, is labeled as low-security. Such a situation represents a potential vulnerability point, because low security information ($fname3) flows on a high-security channel (echo). As described above, this creates an integrity problem that can be exploited by an attacker, for example by launching an SQL injection attack.

Although TSSA resembles the classical information flow security analysis in the example of FIG. 1B, TSSA is more general than information flow analysis and can be used for verifying typestate properties. In particular, TSSA can be used, as described in further detail below, for precise typestate verification for shallow programs.

Property implication problems (PIPs) are motivated can be motivated by one or more of at least three properties: object escape property, variable taintedness property and heterogeneous property implication for bug detection. Recalling that a property P₁ at a location l₁ implies a property P₂ at a location l₂, an object is said to “globally escape” a method if the object can be accessed by a global variable. Many applications require the computation of a global escape property. For example, in Java, if an object is reachable from a static field (global variable), synchronization on the object cannot be eliminated. Escape analysis is performed to compute escape properties for all compile-time objects. Traditional escape analysis iterates over all statements of a program and often does not scale, as it attempts to compute escape properties for all objects, including those that are not on critical paths. It is sufficient in many cases, however, to compute escape properties only for certain “hot” objects that are on critical paths.

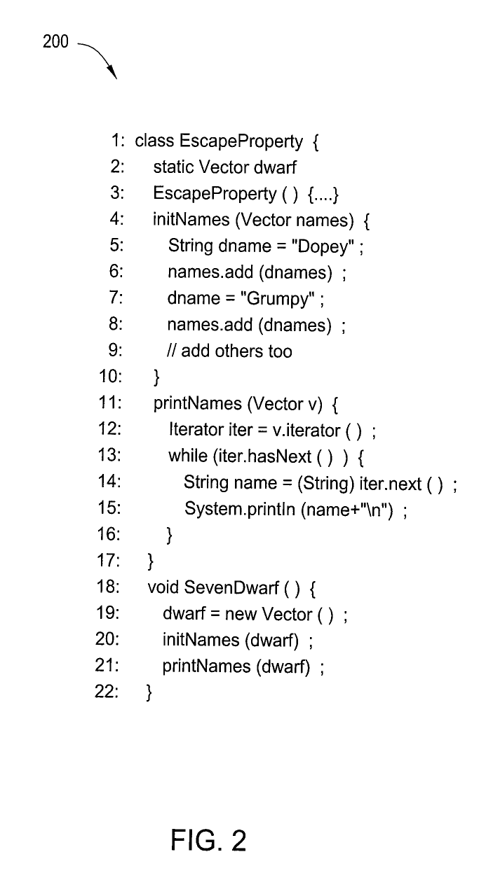

FIG. 2 illustrates an exemplary Java program 200 illustrating the global escape property. Consider the case in which the global escape property must be computed for the string object referenced by name at line 15 of the program 200. The string object escapes if the iterator objected referenced by iter escapes. For the iterator object to escape, the vector object referenced by the parameter vec should escape. Since the interest is not in the iterator object, but in the string object, an escape property dependency is introduced from the parameter vec to the reference name at line 15. This escape property dependency essentially represents the fact that if vec globally escapes, then name also globally escapes. However, if vec does not escape, nothing can be said about the escape property of name. Using the terminology of the SSA form, vec is a “definition” of escape property for the function printNames, and names is the “usage” of the escape property. A “usage” of an escape property can have more than one “definition” of an escape property, and one can insert “escape property φ-nodes” to ensure that every “usage” has a “single definition”. The set of escape property dependencies, along with the relevant φ-nodes, forms a sparse graph that summarizes the effect of a procedure with respect to escape property. Referring to the example of FIG. 2, it is clear that vec escapes, since vec depends on dwarf, which is defined to be a static variable.

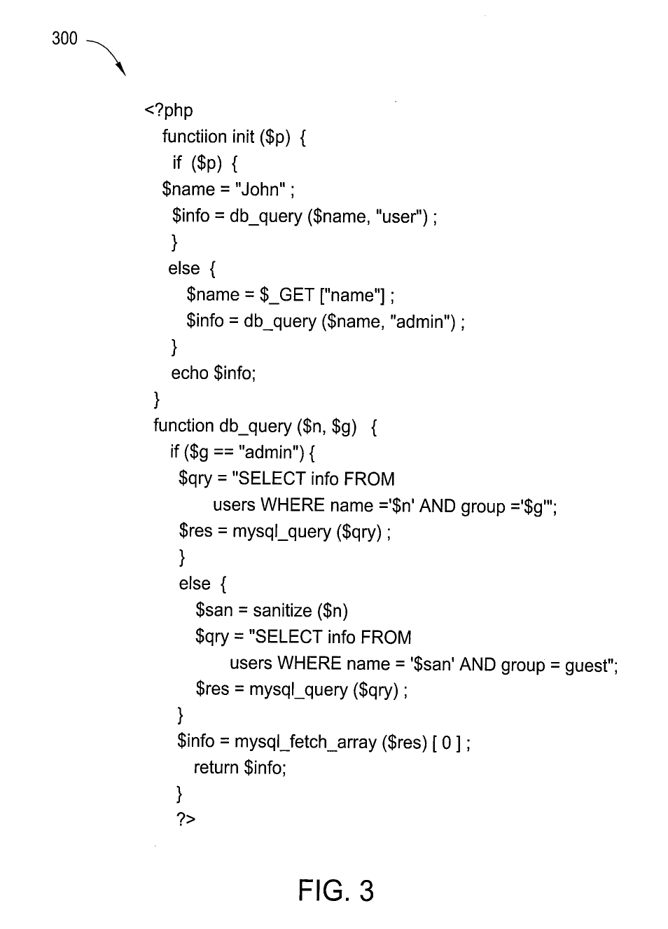

FIG. 3 illustrates an exemplary PHP program 300 illustrating the taint property. In the program 300, the function mysql_query( ) is considered to be trusted since it queries a back-end database. So if $qry is tainted, an attacker can launch a database injunction attack. Note that $qry in the then-branch is tainted if either $g or $n is tainted. Using the terminology of the SSA form, $n and $g “define” taint property, and $qry in the function mysql_query( ) is the “usage” of the taint property. Thus, a “taint property dependency” can be inserted from the parameters $n and $g that define taint property to the usage $qry in the mysql_query( ). It is noted that escape property, described above, and taint property have similar characteristics. It is also noted that the sanitize( ) sanitizes $n, so that mysql_query($qry) is safe to execute.

It is also important to observe that when a property P₁ at a location l₁ implies a property P₂ at a location l₂, it is not necessary that P₁ and P₂ are of the same property type. Consider the following C program, and observe that the division in the print statement would raise an error if *p is zero:

```
int divide(int *p, int *q){
  *p = 1;
  *q = 0;
  printf(“%d\n”, 100/*p)
}
```

Now the division will raise an error only if *p and *q are aliased. A property referred to as “alias property” for the function parameters is defined as Alias(*p, *q). This property is “used” inside the print statement; what this means is that Alias(*p, *q) implies DivisionError. An “alias property dependency” can thus be created that is similar to the escape property dependency and taint property dependency.

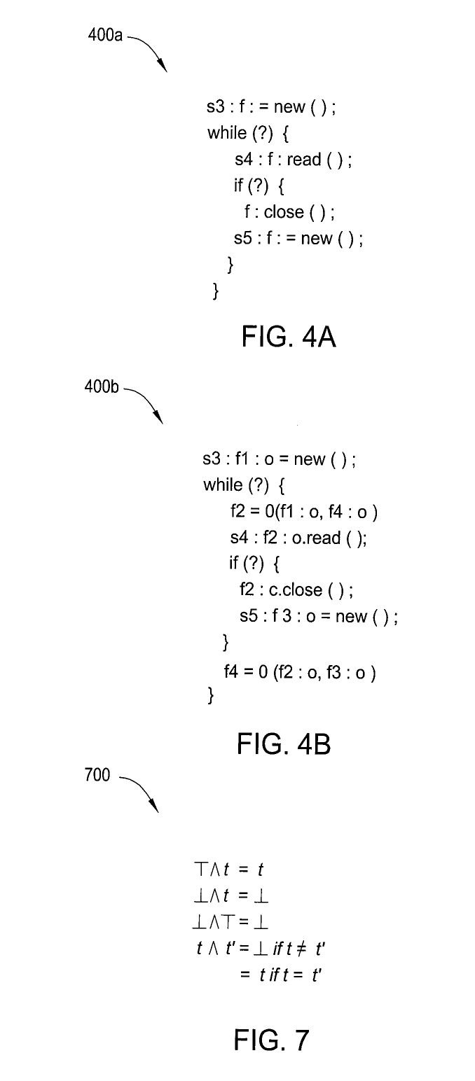

In typestate verification, as discussed herein, objects and variables are associated with a finite set of states called typestates. When invoking an operation on variables or objects, corresponding variables and objects used must be in certain “valid typestates”, otherwise, the operation can raise an exception. Typestate verification involves statically determining if a given program can execute operations on variables and objects that are not in valid typestate. For instance, FIG. 4A illustrates an exemplary program 400a illustrating typestate and alias interaction. The operation f.read is valid only if the typestate of f is open. It is noted that certain operations in a program can alter the typestate of a variable. The operation f.close in FIG. 4 changes the typestate from open to close.

In one embodiment, typestates are modeled using regular expressions. For instance, the problem of checking that a closed file is never read or closed again can be represented as read* ; close. One of the hardest problems in precise typestate verification is the interaction between aliasing and typestate checking. A conventional two-phase approach of alias analysis followed by typestate analysis occasionally leads to imprecise typestate verification. For example, referring back to FIG. 4 and using alias analysis, it is clear that the reference f at statement 4 can point objects created at either of program points s3 and s5. Using typestate analysis, it is also clear that the objects created at s3 and s5 could be in a closed state at s4, indicating a possible typestate error. The two-phase approach discussed above, however, would not be able to discover that f can never point to a closed object at s4.

A simpler sparse technique using TSSA for typestate verification can be implemented instead. FIG. 4B, for instance, illustrates the TSSA form 400B corresponding to the exemplary program 400a of FIG. 4A. In FIG. 4B, the annotations :o indicate the “input” typestate for each statement. One can see from the typestate annotation that there are no typestate errors in the program.

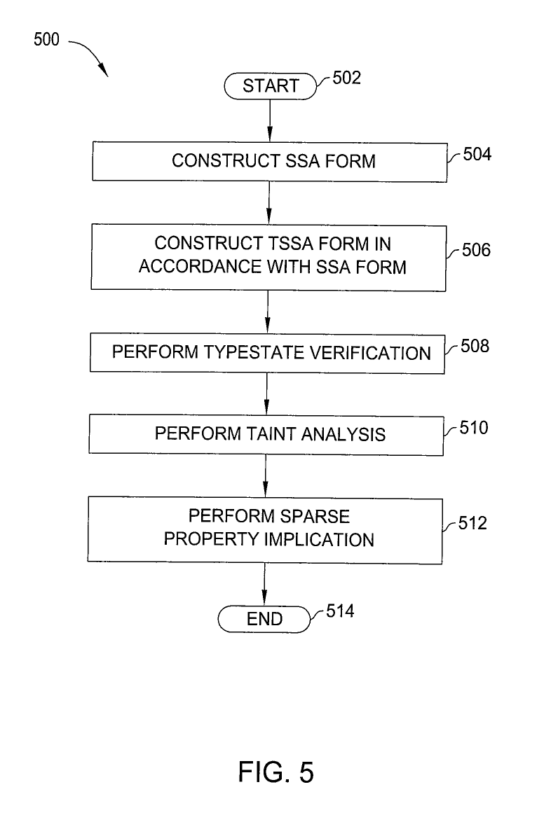

FIG. 5 is a flow diagram illustrating one embodiment of a method 500 for detecting vulnerabilities in a software application, according to the present invention.

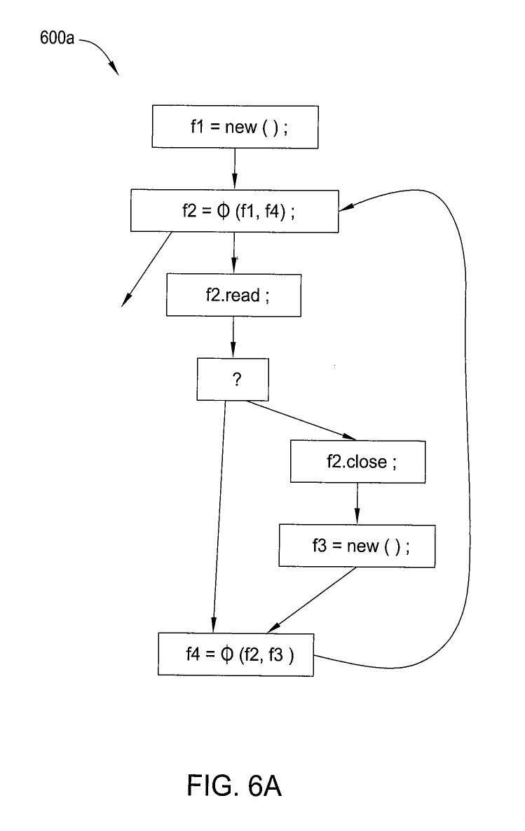

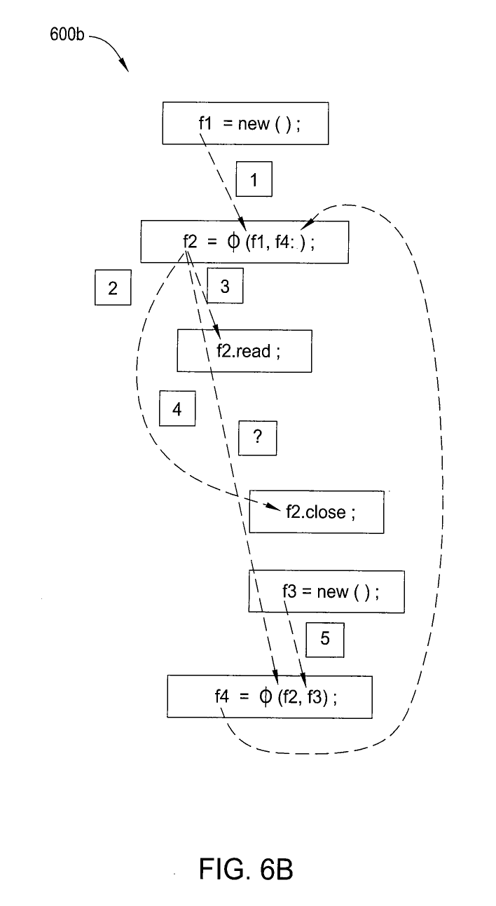

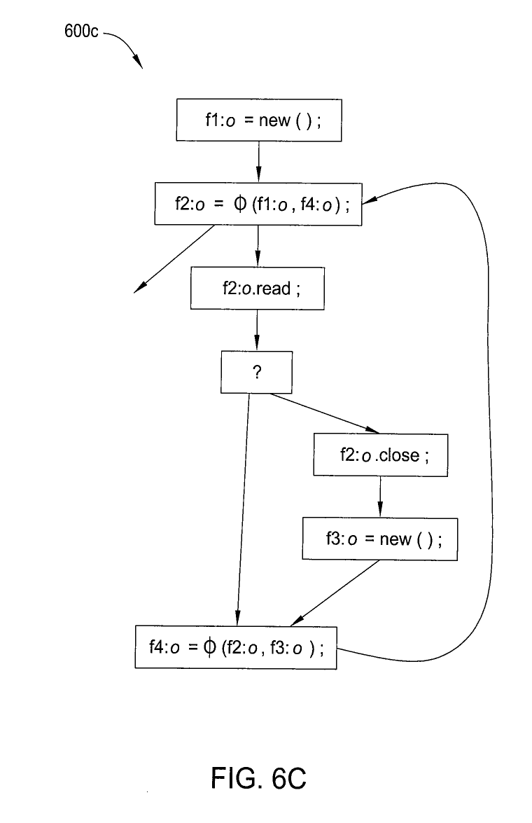

The method 500 is initialized at step 502 and proceeds to step 504, where the method 500 constructs the SSA form for a program, which includes aliasing information. An SSA graph is a graph representation that contains: (1) a set of SSA nodes representing definitions and uses of variables, includes φ-nodes; and (2) a set of SSA edges that connect the definitions of variables to all uses of the variables. For example, FIG. 6A illustrates the SSA form 600a for the exemplary program 400 illustrated in FIG. 4. FIG. 6B, on the other hand, illustrates the SSA form 600b for the exemplary program 400, in which only SSA edges and nodes are illustrated. In this example, the normal φ-nodes are overloaded with typestates to obtain a typestate φ-node. In one embodiment, the SSA form is constructed using any known algorithm for such construction. For instance, one suitable algorithm that may be implemented in step 504 is described by Cytron et al. in “Efficiently Computing Static Single Assignment Form and the Control Dependence Graph”, Proceedings of the ACM Transactions on Programming Languages and Systems (TOPLAS), 1991.

In one embodiment, a form of SSA referred to as “gated SSA” (GSSA) is implemented in accordance with step 104. GSSA also associates control flow predicates with φ-functions, and these predicates act as “gates” that allow only one of (x₀, x₁, x₂, . . . , xₙ₋₁) variables to be assigned to xₙ.

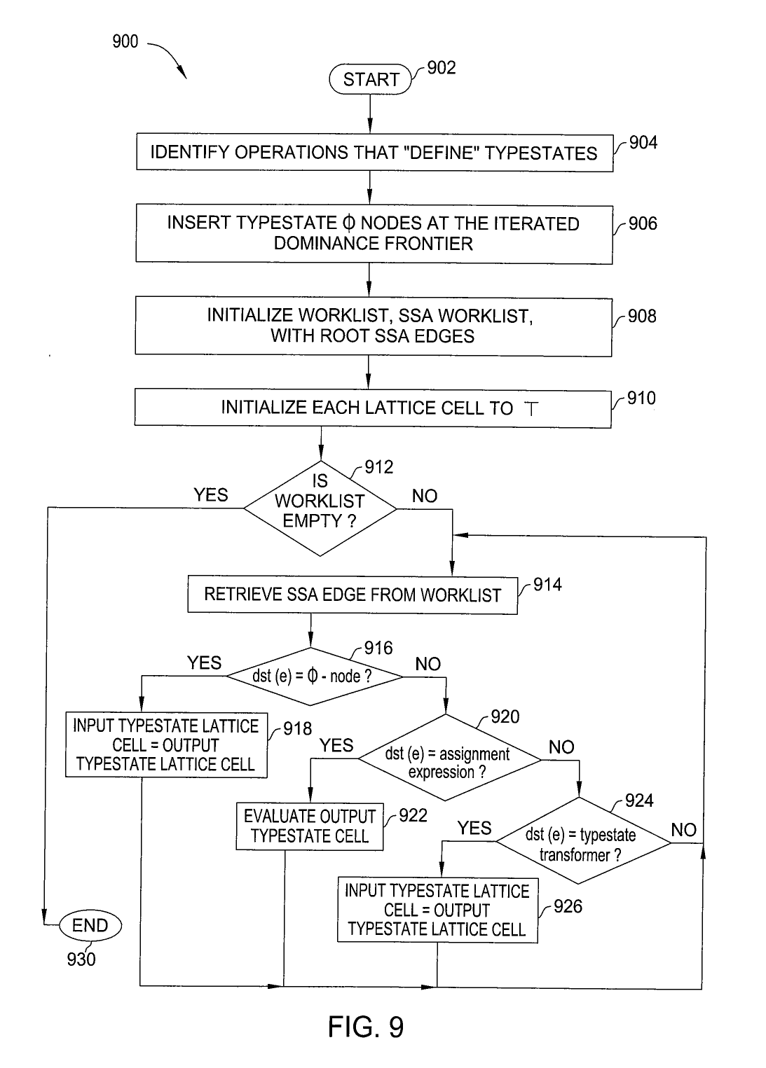

Referring back to FIG. 5, once the SSA form is constructed, the method 500 proceeds to step 506 and constructs the TSSA form corresponding to the SSA form. In one embodiment, construction of the TSSA form involves inserting typestate φ-nodes (in addition to normal φ-nodes from the SSA graph) that merge typestate information and propagating the typestate information over the SSA form. One embodiment of a method for constructing the TSSA form from the SSA form is described below with reference to FIG. 9. TSSA form extends the SSA form with typestate information. For example, FIG. 6C illustrates the TSSA form 600c that corresponds to the SSA form 600a illustrated in FIG. 6A. As illustrated, each variable carries the typestate information with it. At φ-nodes, typestates are merged according to the lattice illustrated in FIG. 7, which illustrates a typestate lattice operation 700.

In particular, FIG. 7 illustrates a lattice or set, T, of typestates that includes two distinguished typestates: [symbol] and ⊥. [symbol] and ⊥ are ordered (⊂) with respect to elements t of T as follows:

⊥ ⊂ t

t ⊂

[symbol]

⊥ ⊂

[symbol]

In other words, the set T′= [symbol] ∪⊥∪T forms a lattice, with the meet ( [symbol] ) operation shown in FIG. 7 (where t, t′ ε T). Intuitively, ⊥ is an undefined typestate, and it is an error to operate on a variable whose typestate is undefined. The typestate [symbol] is an undetermined typestate. For simplicity, it is assumed that the typestate elements in the set T are not compatible with each other.

In one embodiment, typestate propagation over the TSSA form is based on a security lattice model. The model is based on a simple lattice of security levels whose elements are { [symbol] , H, L}, with the meet operation that satisfies the following: Let [symbol] be the meet operation on the elements of the lattice. Then [symbol] [symbol] H=H [symbol] L=L, and [symbol] [symbol] L=L, where [symbol] designates as-yet undefined security labels. The security labels are then propagated in a top-down manner (with respect to the SSA form) over the variables of the program under analysis, resulting in the TSSA form.

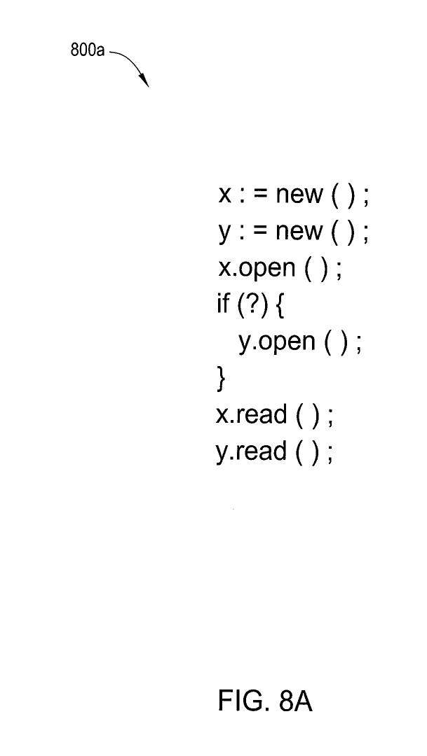

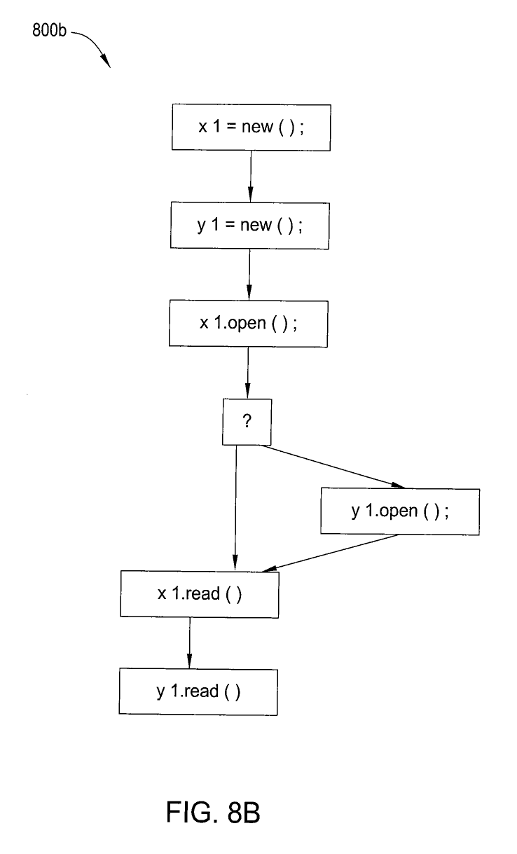

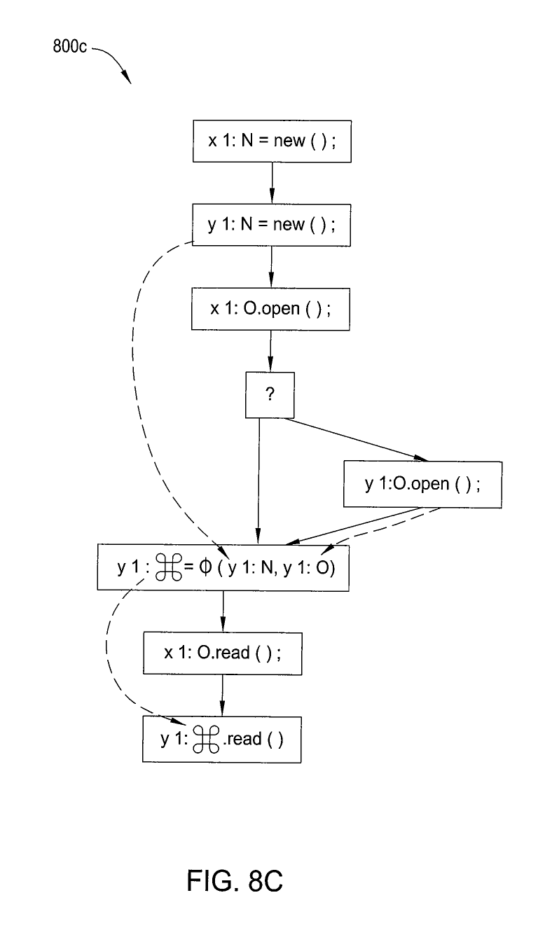

In another class of typestate problem, referred to as open+;read, typestate verification is PSPACE-complete. For a special class, open:read, a polynomial time verification implementing a counting mechanism can be used. For example, FIG. 8A illustrates an example of an open;read class 800a. FIG. 8B illustrates the corresponding SSA form 800b. Note that in the SSA form 800b, the SSA form does not need φ-nodes for merging variables x and y. FIG. 8C illustrates the TSSA form 800c corresponding to the SSA form 800b of FIG. 8b. In the TSSA form 800c, typestates N and O are used, where N indicates a “new” object state, and O indicates an “open” object state. For typestate verification, one wants to ensure that read operations can only be performed in typestate O. Note that in FIG. 8C, a typestate φ-node is introduced to merge typestates N and O. Using the lattice from FIG. 7, the result of this merge is a ⊥. The ⊥ typestate is propagated to the “use” in y1.read. Intuitively, ⊥ indicates an error typestate.

As discussed above, construction of the TSSA form involves inserting typestate φ-nodes and propagating the typestate information over the SSA form. In order to accomplish this task, two typestate calls, TCellᵢ and TCellₒ, are first associated with the typestate value of each variable at each node in the SSA form. TCellᵢ stores the input typestate lattice value of a node, and TCellₒ stores the output typestate lattice value of the node. Each typestate cell is initialized with a lattice value of [symbol] . For each operation that defines a typestate in FIG. 4 (e.g., f.close), the corresponding TCellₒ is given the corresponding typestate (e.g., close). If dst(e) denotes the destination node of an SSA edge, e, and src(e) denotes the source node of the SSA edge, e, then an SSA edge is said to be a root SSA edge if src(e) has no incoming edge. One embodiment of a method for typestate propagation, discussed in further detail below with respect to FIG. 9, uses a worklist of SSA edges, SSA Worklist.

Referring back to FIG. 5, in step 508 the method 500 performs typestate verification. Typestate verification is relatively straightforward given the TSSA form. In one embodiment, each operation is checked to determine whether the corresponding typestate is legal for that operation. For example, open in a legal typestate for a read operation. In one embodiment, ⊥ is always considered to be an illegal typestate for an operation. The typestate assignments illustrated in FIG. 8C are legal assignments. In one embodiment, the running time complexity for typestate verification for omission-closed shallow programs is O(V×E).

Note that the typestate lattice illustrated in FIG. 7 cannot deal with operations that accept more than one typestate for a variable. Consider the following simple example that permits a file to be read, f.read( ), if the typestate of f is either open or cached.

```
function foo(File f){
  if(?)
    f.open( ); \\ typestate open
  else
    f.cache( ); \\ typestate cache
    f.read( );
}
```

The operation f.read is valid when f is in typestate open or cached. Therefore, when merging at the typestate φ-node, it is important not to lose the typestate information by lowering open̂cache to ⊥. For such multi-typestate verification, an appropriate lattice is constructed for the typestate property that is being verified.

Once typestate verification has been performed, the method 500 proceeds to step 510 and performs taint analysis. As discussed above, the method 500 uses taint analysis, rather than, for example, information flow analysis, to detect security vulnerabilities (e.g., SQL injection, cross-site scripting or the like) in the program under analysis. A typestate error occurs whenever a high-security function operates on low-security data. Thus, taint analysis involves identifying sensitive functions that can operate only on variables and objects that are in typestate H (high-security). Further, taint analysis attempts to ensure that tainted data does not reach and is not manipulated by these security-sensitive functions. In one embodiment, for PHP programs, all user inputs and uninitialized variables (i.e., variables that have not been assigned starting values) are associated with typestate L. It is important to remember that there is no partial ordering between L and H in typestate analysis. A typestate transformer, Sanitize(x): T(x)→H, is defined, where T(x) is the current typestate of x. In one embodiment, typestates L and H are extended with lattice structure [symbol] and ⊥ (See FIG. 7). The lattice structure aids in the propagation of typestates over the SSA form.

In the exemplary context of PHP, security sensitive functions include functions that access system resources (i.e., system hardware, software, memory, processing power, bandwidth or the like, such as ports, file systems, databases, etc.) and functions that send information back to a client (such as functions that trigger JavaScript code on a client browser).

One way to reduce the risk of vulnerabilities due to tainted data is to sanitize the data, before using it in a sensitive operation or function, by passing it to a sanitization function that transforms low-security objects into high-security objects. For typestate taint analysis, such sanitization functions are modeled using the Sanitize( ) typestate transformer.

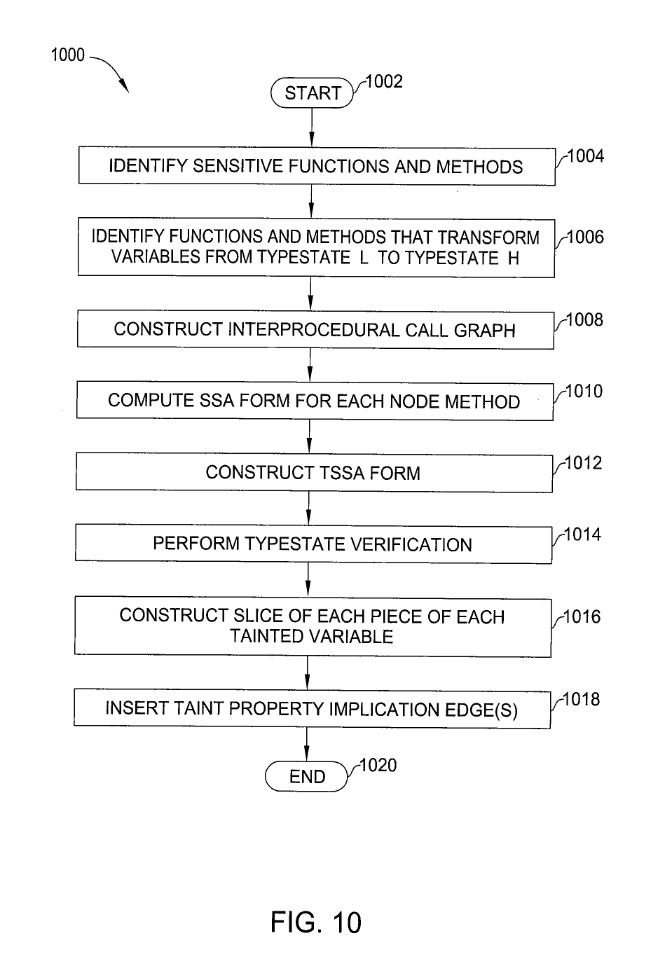

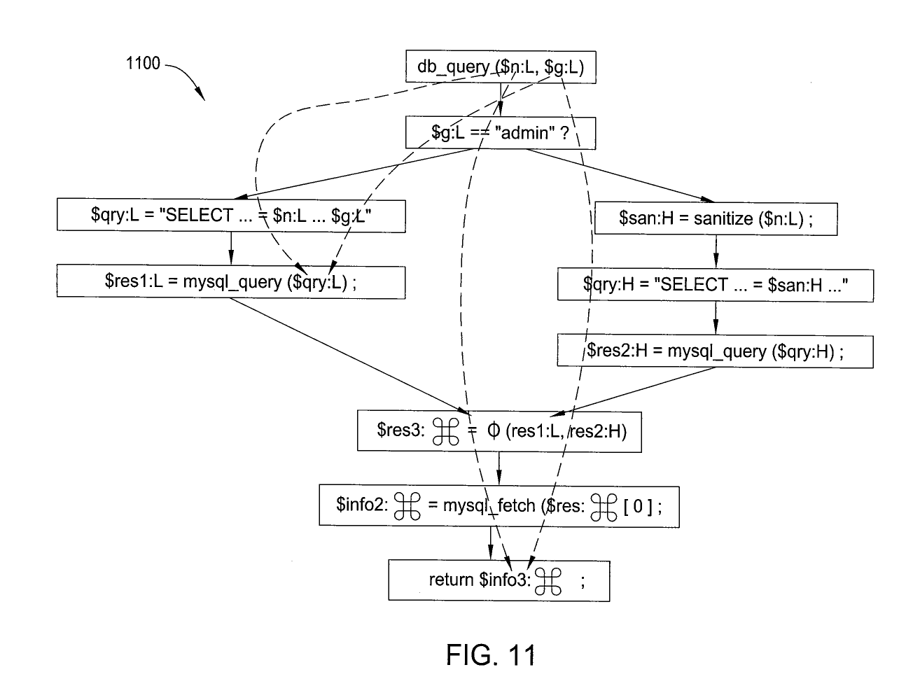

In step 512, the method 500 performs sparse property implication. In one embodiment, this involves constructing a sparse property implication graph (SPIG) in a bottom-up manner over the call graph of the program under analysis. As discussed above, the SPIG summarizes the effects of a function with respect to a property under consideration—in the present case, the taint property. FIG. 11, for example, illustrates an exemplary SPIG 1100 for the method db_query( ) shown in FIG. 3. One embodiment of a method for constructing a SPIG is described in greater detail with respect to FIG. 10. The method 500 then terminates in step 514.

FIG. 9 is a flow diagram illustrating one embodiment of a method 900 for constructing the TSSA form from the SSA form, according to the present invention. The method 900 works from the assumption that the SSA form is constructed and given (e.g., in the manner described with reference to FIG. 5).

The method 900 is initialized at step 902 and proceeds to step 904, where the method 900 identifies operations that “define” typestates. For example, f.open and f.close “define.” the typestates O and C, respectively. Let Nₜ be the set of typestate definitions.

In step 906, the method 900 inserts typestate φ-nodes at the iterated dominance frontier (IDF(Nₜ)). In step 908, the method 900 initializes the worklist, SSA Worklist, with root SSA edges. For example, in FIG. 6C, the SSA Worklist initially contains the root SSA edges [1] and [5]. The method 900 then initializes the lattice cell to [symbol] in step 910.

In step 912, the method 900 determines whether the worklist, SSA Worklist, is empty. If the method 900 determines in step 912 that the worklist is empty, the method 900 terminates in step 930. Alternatively, if the method 900 determines in step 912 that the worklist is not empty, the method 900 proceeds to step 914 and retrieves an SSA edge from the worklist.

In step 916, the method 900 determines whether the destination node of the retrieved SSA edge is a φ-node. If the method 900 determines in step 916 that the destination node of the retrieved SSA edge is a φ-node, the method 900 proceeds to step 918 and sets the value of the input typestate lattice cell for each operand equal to the value of the output typestate lattice cell of the definition end of the SSA edge. In one embodiment, the output typestate lattice cell value for the φ-node is computed using the typestate lattice operation illustrated in FIG. 7. The method 900 then returns to step 914 and proceeds as described above to process a new SSA edge from the worklist.

Alternatively, if the method 900 determines in step 916 that the destination node of the retrieved SSA edge is not a φ-node, the method 900 proceeds to step 920 and determines whether the destination node of the retrieved SSA edge is an assignment expression. If the method 900 determines in step 900 that the destination node of the retrieved SSA edge is an assignment expression, the method 900 proceeds to step 922 and evaluates the value of the output typestate cell of the definition value (lvalue). In one embodiment, the value of the output typestate cell of the definition value (lvalue) is evaluated from the typestate of the expression (rvalue). In one embodiment, the typestate value of the expression is computed by obtaining the values of the operands from the output typestate lattice cell of the definition end of the operand's SSA edge, and then using the typestate lattice operation illustrated in FIG. 7. If this changes the value of the output cell of the expression, then all of the outgoing SSA edges are added to SSA Worklist. The method 900 then returns to step 914 and proceeds as described above to process a new SSA edge from the worklist.

Alternatively, if the method 900 determines in step 920 that the retrieved SSA edge is not an assignment expression, the method 900 proceeds to step 924 and determines whether the retrieved SSA edge is a typestate transformer (e.g., such as f.close). If the method 900 determines in step 924 that the retrieved SSA edge is a typestate transformer, the method 900 proceeds to step 926 and sets the value of the input typestate lattice cell of the operand (e.g., f) equal to the value of the output typestate lattice cell of the definition end of the SSA edge. The output typestate cell value is defined by the typestate transformer (e.g., close for the output typestate cell of f.close). The method 900 then returns to step 914 and proceeds as described above to process a new SSA edge from the worklist. The method 900 thus iterates until the worklist, SSA Worklist, is empty.

As discussed above, the SSA Worklist initially contains the root SSA edges [1] and [5]. The output typestate cell of f1 and f3 contains the typestate value o (open), since the corresponding new( ) generates the open typestate. The edge [1], whose destination node is a φ-node ((φ(f1, f4), is processed first. The input typestate cell of operand f1 is the same as the output typestate value of the SSA definition of f1, which is o. The input typestate cell of operand f4 is the same as the output typestate value of the SSA definition of f4, which is [symbol] The φ-node typestate is evaluated using the lattice illustrated in FIG. 7, and this results in the assignment of the output typestate cell value of o to the operand f2. This output typestate value is propagated along edges [2], [3] and [4]. When processing the operation f2.close, the input typestate cell is assigned the value o, and the output typestate cell is assigned the value c (close). FIG. 8C, discussed above, illustrates the typestate assignment for each reference when the method 900 terminates.

FIG. 10 is a flow diagram illustrating one embodiment of a method 1000 for detecting vulnerabilities in a software application, according to the present invention. The method 1000 elaborates on the method 500 described above with respect to FIG. 5, particularly with reference to the construction of the sparse property implication graph (SPIG). Referring simultaneously to FIG. 11 and FIG. 10, the method 1000 is initialized at step 1002 and proceeds to step 1004, where the method 1000 identifies all sensitive functions and methods in the program under analysis (in the exemplary case of FIG. 11, msql_query( )).

In step 1006, the method 1000 identifies all functions and methods that transform the typestate of a variable or object from L to H (in the exemplary case of FIG. 11, sanitize( )). The method 1000 then proceeds to step 1008 and constructs an interprocedural call graph for the program under analysis, visiting the nodes in the call graph using post-order traversal.

In step 1010, for each node method, m, (in the exemplary case of FIG. 11, db_query($n, $g)) visited in post order, the SSA form is computed by considering all formal parameters as definition points (in the exemplary case of FIG. 11, $n, $g).

In step 1012, the TSSA form is constructed. In one embodiment, construction of the TSSA form involves assigning typestate L to all formal parameters of the method, m (in the exemplary case of FIG. 11, $n:L, $g:L).

In step 1014, the method 1000 performs typestate verification using the TSSA form, as described above, by checking sensitive operations to determine if they raise typestate errors (in the exemplary case of FIG. 11, mysl_query($qry:L) on the then-part). Remember that typestate L is initially assigned to all formal parameters in step 1012.

In step 1016, for each piece of a tainted variable, t, in a sensitive operation, fₛ, (in the exemplary case of FIG. 11, $qry:L in mysql_query( )) whose typestate is L, a slice of the variable is constructed. The method 1000 then determines which of the formal parameters, F, (in the exemplary case of FIG. 11, $n, $g) contribute to the typestate failure of the sensitive operation, fₛ.

In step 1018, for each formal parameter, pε F, that contributes to the typestate failure of the sensitive operation, fₛ, a taint property implication edge, eₜᵢ, (illustrated in FIG. 11 as a dotted line) is inserted from p (in the exemplary case of FIG. 11, $n, $g) to x (in the exemplary case of FIG. 11, $qry). The property implication encodes the fact that if the formal parameter, p, is tainted, then the operation, x, is also tainted. It is important to note that if the formal parameter, p, is not tainted, then nothing can be inferred about the operation, x. Note also that in the exemplary case of FIG. 11, the mysql_query( ) on the else-part will never be tainted.

In step 1020, the method 1000 inserts dependence edges (illustrated in FIG. 11 as dotted lines from formal parameters to the return value $info) from each of the input formal parameters of the method, m, to output variables (including return variables) that flow out of the method, m. These output variables have data/control flow dependencies on the formal parameters. This essentially “short circuits” input variables to output variables of the method, m. These short circuit dependencies are used when processing the caller function and can easily be computed by constructing slices for each input variable, then inserting a short circuit edge from a formal parameter that is in the slice to the output variable.

Although the present invention is described within the exemplary context of the Web application domain built using the LAMP (Linux, Apache, mySQL and Hypertext Preprocessor (PHP)/Perl/Python) stack, those skilled in the art will appreciate that the concepts of the present invention may be extended to implementation in a variety of application domains (e.g., Java J2EE, .NET) and programming languages (e.g., Java, C#, JavaScript, C, C++).

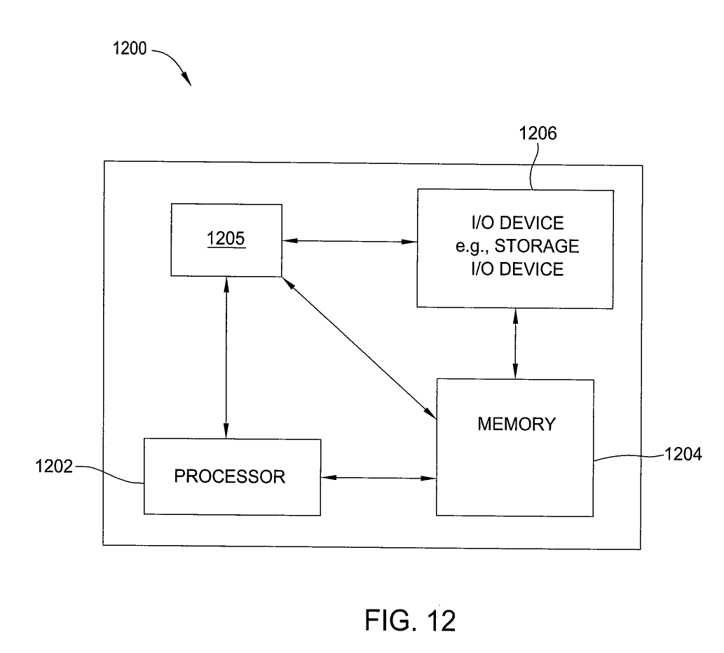

FIG. 12 is a high level block diagram of the vulnerability and bug detection method that is implemented using a general purpose computing device 1200. In one embodiment, a general purpose computing device 1200 comprises a processor 1202, a memory 1204, a vulnerability/bug detection module 1205 and various input/output (I/O) devices 1206 such as a display, a keyboard, a mouse, a modem, and the like. In one embodiment, at least one I/O device is a storage device (e.g., a disk drive, an optical disk drive, a floppy disk drive). It should be understood that the vulnerability/bug 1205 can be implemented as a physical device or subsystem that is coupled to a processor through a communication channel.

Alternatively, the vulnerability/bug detection module 1205 can be represented by one or more software applications (or even a combination of software and hardware, e.g., using Application Specific Integrated Circuits (ASIC), Field Programmable Gate Arrays (FPGAs) or Digital Signal Processors (DSPs)), where the software is loaded from a storage medium (e.g., I/O devices 1206) and operated by the processor 1202 in the memory 1204 of the general purpose computing device 1200. Thus, in one embodiment, the vulnerability/bug detection module 1205 for detecting vulnerabilities and bugs in software applications described herein with reference to the preceding Figures can be stored on a computer readable medium or carrier (e.g., RAM, magnetic or optical drive or diskette, and the like).

Thus, the present invention represents a significant advancement in the field of computer security. Embodiments of the present invention enable ready detection of potential security vulnerabilities and bugs, such as vulnerabilities to cross-site scripting and SQL injection. By tracking the actual flow or propagation of tainted data through a program under analysis, in accordance with the sparse property implication graph, the present invention pinpoints instructions that are vulnerable to particular attacks. The present invention has the advantage of working on a summary of an initial call graph, which allows the analysis to scale well to more complex programs. The present invention provides information on tainted data very quickly, directing attention to specific instructions that are believed to be vulnerable.

While foregoing is directed to the preferred embodiment of the present invention, other and further embodiments of the invention may be devised without departing from the basic scope thereof, and the scope thereof is determined by the claims that follow.

1. A method for detecting a vulnerability in a computer software application comprising a plurality of variables, the variables having respective values and including data and functions that operate on the data, the method comprising:
detecting at least one piece of data that is tainted;
tracking a propagation of the at least one piece of tainted data through the software application; and
identifying the functions that are security sensitive and that are reached by the at least one piece of tainted data in the propagation.

2. The method of claim 1, wherein the tracking comprises:
constructing a static single assignment form of the software application;
constructing a typestate static single assignment form of the software application, in accordance with the static single assignment; and
constructing a sparse property implication graph of the software application in accordance with the typestate static single assignment form.

3. The method of claim 2, wherein the static single assignment form is a gated static single assignment form.

4. The method of claim 2, wherein constructing the typestate static single assignment form comprises:
inserting at least one typestate phi-node into the static single assignment form;
assigning a typestate label to each of the plurality of variables, the typestate label indicating that a variable associated with the typestate label is either a high-security object or a low-security object; and
propagating the typestate label for each of the plurality of variables over the static single assignment form to construct the typestate static single assignment form.

5. The method of claim 4, comprising:
designating a piece of data as tainted if the piece of data is labeled as low-security and flows through a channel to a high-security function.

6. The method of claim 4, wherein the assigning comprises:
labeling all user inputs and uninitialized variables as low-security; and
labeling all sensitive functions as high-security, a sensitive function being a function that can operate only on high-security variables.

7. The method of claim 6, wherein the sensitive functions include at least one of: a function that accesses a computer system resource and a function that sends information to a client.

8. The method of claim 4, wherein the propagating is performed in accordance with a lattice of typestate labels.

9. The method of claim 4, wherein the typestate labels are propagated in a top-down manner relative to the static single assignment form over the plurality of variables.

10. The method of claim 4, wherein the propagating comprises:
associating a first typestate cell with each value of each variable at each node in the static single assignment form, the first typestate cell storing an input typestate lattice value of a corresponding node;
associating a second typestate cell with each value of each variable at each node in the static single assignment form, the second typestate cell storing an output typestate lattice value of a corresponding node;
initializing the first typestate cell with a first lattice value; and
assigning to the second typestate cell a typestate from a corresponding function in the software application.

11. The method of claim 2, wherein constructing a sparse property implication graph comprises:
verifying, for each function of the software application, that a typestate corresponding to the function is legal for the function; and
identifying each sensitive function of the software application, a sensitive function being a function that can operate only on high-security variables.

12. The method of claim 11, further comprising:
sanitizing any data that is to be passed to a sensitive function, the sanitizing comprising transforming the data from a low-security object into a high-security object.

13. A computer readable medium containing an executable program for detecting a vulnerability in a computer software application comprising a plurality of variables, the variables having respective values and including data and functions that operate on the data, where the program performs the steps of:
detecting at least one piece of data that is tainted;
tracking a propagation of the at least one piece of tainted data through the software application; and
identifying any functions that are security sensitive and that are reached by the at least one piece of tainted data in the propagation.

14. The computer readable medium of claim 13, wherein the tracking comprises:
constructing a static single assignment form of the software application;
constructing a typestate static single assignment form of the software application, in accordance with the static single assignment; and
constructing a sparse property implication graph of the software application in accordance with the typestate static single assignment form.

15. The computer readable medium of claim 14, wherein constructing the typestate static single assignment form comprises:
inserting at least one typestate phi-node into the static single assignment form;
assigning a typestate label to each of the plurality of variables, the typestate label indicating that a variable associated with the typestate label is either a high-security object or a low-security object; and
propagating the typestate label for each of the plurality of variables over the static single assignment form to construct the typestate static single assignment form.

16. The computer readable medium of claim 15, comprising:
designating a piece of data as tainted if the piece of data is labeled as low-security and flows through a channel to a high-security function.

17. The computer readable medium of claim 15, wherein the propagating is performed in accordance with a lattice of typestate labels.

18. The computer readable medium of claim 14, wherein constructing a sparse property implication graph comprises:
verifying, for each function of the software application, that a typestate corresponding to the function is legal for the function; and
identifying each sensitive function of the software application, a sensitive function being a function that can operate only on high-security variables.

19. Apparatus for detecting a vulnerability in a computer software application comprising a plurality of variables, the variables having respective values and including data and functions that operate on the data, the apparatus comprising:
means for detecting at least one piece of data that is tainted;
means for tracking a propagation of the at least one piece of tainted data through the software application; and
means for identifying any functions that are security sensitive and that are reached by the at least one piece of tainted data in the propagation.

20. A method for detecting a bug in a computer software application comprising a plurality of variables, the variables having respective values and including data and functions that operate on the data, the method comprising:
detecting at least one piece of data, the at least one piece of data being in a first typestate;
tracking a propagation of the first typestate through the software application; and
identifying at least one function that is reached by the at least one piece of data, for which the first typestate is illegal.
